(19) United States
(12) Patent Application Publication
(10) Pub. No.: US 2012/0262280 A1
(43) Pub. Date: Oct. 18, 2012

(54) CONTROLLED DEVICE AND CONTROL SYSTEM USING RADIO-FREQUENCY IDENTIFICATION TECHNOLOGY

(75) Inventors: Yin-Hung Tseng, Chiayi City (TW); Chih-Hao Hsu, Taitung Hsien (TW)

(73) Assignee: USERSTAR INFORMATION SYSTEM CO., LTD.

(21) Appl. No.: 13/086,965

(22) Filed: Apr. 14, 2011

(51) Int. Cl. G06K 7/01

(52) U.S. Cl. 340/10.5

(57) ABSTRACT

A control system includes a portable electronic device and a controlled device. The portable electronic device includes a user input unit, a first processing unit, and a transmitting unit. The controlled device includes a controlled module and an RFID tag. The RFID tag includes a receiving unit, a tag memory unit storing a first code, and a second processing unit. The portable electronic device generates and wirelessly transmits a first key and a control command according to user operation of the user input unit. The second processing unit of the controlled device is configured to determine, with reference to the first key received by the receiving unit and the first code, whether or not to output a control signal for controlling the controlled module to perform an action that corresponds to the control command received by the receiving unit.

### BACKGROUND OF THE INVENTION

1. Field of the Invention

The present invention relates to a controlled device and a control system, more particularly to a controlled device and a control system using radio-frequency identification technology.

2. Description of the Related Art

A conventional control system utilizing radio-frequency identification (RFID) technology and disclosed in Taiwanese Patent Publication No. I305758 is illustrated in FIG. 1. The control system includes a lock module 50, a RFID tag 51, and a RFID reader 52 disposed in the lock module 50. The lock module 50 is configured to access data stored in the RFID tag 51 via the RFID reader 52, and is configured to determine, with reference to the data accessed by the RFID reader 52, whether or not to unlock. Since the lock module 50 of the control system employs an induction type unlocking scheme, it is relatively fast and convenient to unlock the lock module 50 because it is not required to insert a physical key into a keyhole and to turn the physical key when unlocking the lock module 50.

However, since a cost of the RFID reader 52 is relatively high compared to the RFID tag 51, a price of the lock module 50 may not be effectively reduced if the RFID reader 52 is incorporated in the lock module 50.

### SUMMARY OF THE INVENTION

Therefore, an object of the present invention is to provide a controlled device having a relatively low cost and using Radio-Frequency identification (RFID) technology to receive a control command.

Accordingly, the controlled device of the present invention includes a controlled module and an RFID tag.

The RFID tag includes, a receiving unit, a memory unit, and a processing unit. The receiving unit wirelessly receives a first key and the control command. The memory unit stores a first code. The processing unit is electrically coupled to the receiving unit and the memory, unit and is further electrically coupled to the controlled module.

The processing unit is configured to determine, with reference to the first key received by the receiving unit and the first code stored in the memory unit, whether or not to output a control signal for controlling the controlled module to perform an action that corresponds to the control command received by the receiving unit.

Another object of the present invention is to provide a control system having a relatively low cost, and using RFID technology to transmit and receive a control command.

Accordingly, the control system of the present invention includes a portable electronic crevice and a controlled device.

The portable electronic device includes a user input unit, a first processing unit, and a transmitting unit. The first processing unit is electrically coupled to the user input unit, and generates a first key and a control command according to user operation of the user input unit. The transmitting unit is electrically coupled to the first processing unit, and wirelessly transmits the first key and the control command.

The controlled device includes a controlled module and an RFID tag. The RFID tag includes a receiving unit, a tag memory unit, and a second processing unit. The receiving unit wirelessly receives the first key and the control command from the transmitting unit of the portable electronic device. The tag memory unit stores a first code. The second processing unit is electrically coupled to the receiving unit and the tag memory unit and is further electrically coupled to the controlled module. The second processing unit is configured to determine, with reference to the first key received by the receiving unit and the first code stored in the tag memory unit, whether or not to output a control signal for controlling the controlled module to perform an action that corresponds to the control command received by the receiving unit.

The present invention may achieve an effect of cost reduction of the controlled device by replacing an RFID reader with an RFID tag in the controlled device.

### BRIEF DESCRIPTION OF THE DRAWINGS

Other features and advantages of the present invention will become apparent in the following detailed description of the two preferred embodiments with reference to the accompanying drawings, of which:

FIG. 1 is a block diagram illustrating a conventional control system using radio-frequency identification (RFID) technology;

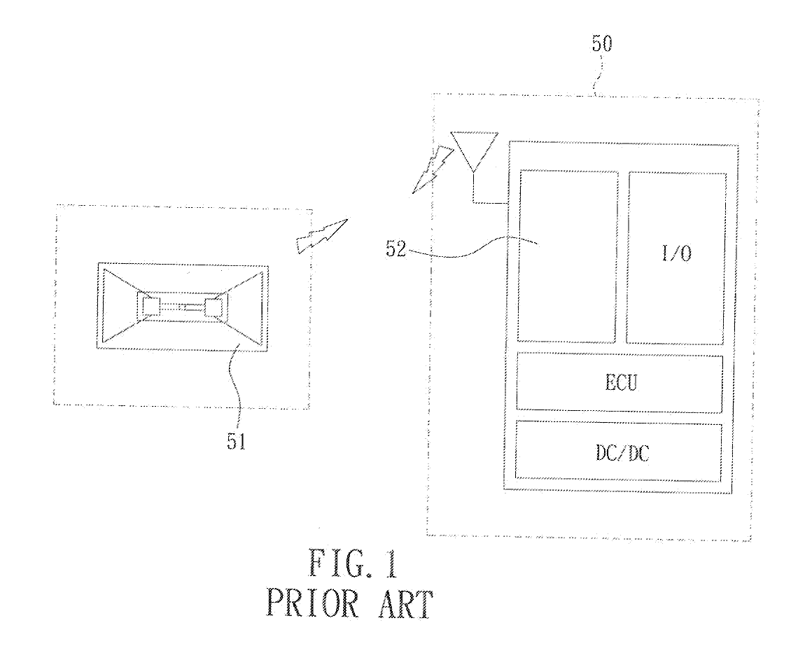

FIG. 2 is a block diagram illustrating a first preferred embodiment of a control system of the present invention;

FIG. 3 is a block diagram illustrating a modified controlled module of the first preferred embodiment of the present invention;

FIG. 4 is a block diagram illustrating a second preferred embodiment of the control system of the present invention;

FIG. 5 is a flowchart illustrating an operational procedure which adopts an accumulative scheme in updating an error count of the second preferred embodiment of the present invention;

FIG. 6 is a flowchart illustrating an operational procedure which adopts a subtractive scheme in updating an error count of the second preferred embodiment of the present invention; and

FIG. 7 is a block diagram illustrating a modified controlled module of the second preferred embodiment of the present invention.

### DETAILED DESCRIPTION OF THE PREFERRED EMBODIMENTS

Before the present invention is described in greater detail with reference to the preferred embodiments, it should be noted that the same reference numerals are used to denote the same elements throughout the following description.

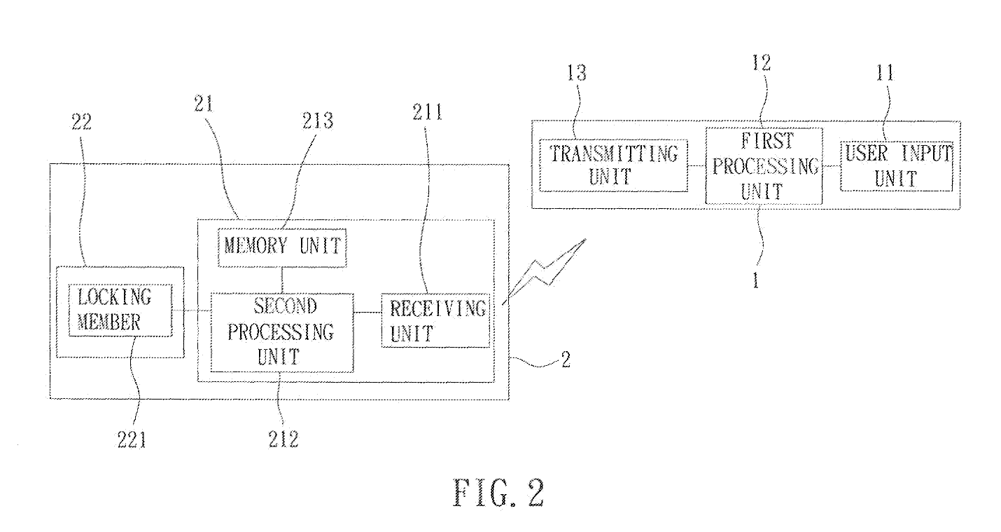

Referring to FIG. 2, a first preferred embodiment of a control system of the present invention includes a portable electronic device 1 and a controlled device 2. The portable electronic device 1 and the controlled device 2 communicate with each other wirelessly.

The portable electronic device 1 includes a user input unit 11, a first processing unit 12, and a transmitting unit 13. The user input unit 11 includes a plurality of input keys (not Shown). The first processing unit 12 is electrically coupled to the user input unit 11, and generates a first key and a control command according to user operation of the user input unit 11. The transmitting unit 13 is electrically coupled to the first processing unit 12 for wirelessly transmitting the first key and the control command to the controlled device 2. The portable electronic device is a mobile phone in this embodiment.

The controlled device 2 includes a radio-frequency identification (RFID) tag 21 and a controlled module 22. The RFID tag 21 includes a receiving unit 211, a memory unit 213, and a second processing unit 212. The receiving unit 211 is electrically coupled to the second processing unit 212 for transmitting the first key and the control command wirelessly received from the transmitting unit 13 of the portable electronic device 1 to the second processing unit 212. The memory unit 213 stores a first code. The second processing unit 212 is electrically coupled to the receiving unit 211 and the memory unit 213 and is further electrically coupled to the controlled module 22. The second processing unit 212 is configured to determine, with reference to the first key received by the receiving unit 211 and the first code stored in the memory unit 213, whether or not to output a control signal for controlling the controlled module 22 to perform an action that corresponds to the control command received by the receiving unit 211. In this embodiment, the second processing unit 212 transmits the control signal to the controlled module 22 upon determining that the first key conforms with the first code. Otherwise, the second processing unit 212 remains idle upon determining, that the first key does not conform with the first code. In the first preferred embodiment, the controlled module 22 includes a locking member 221 that is switched between locking and unlocking states according to the control signal from the second processing unit 212.

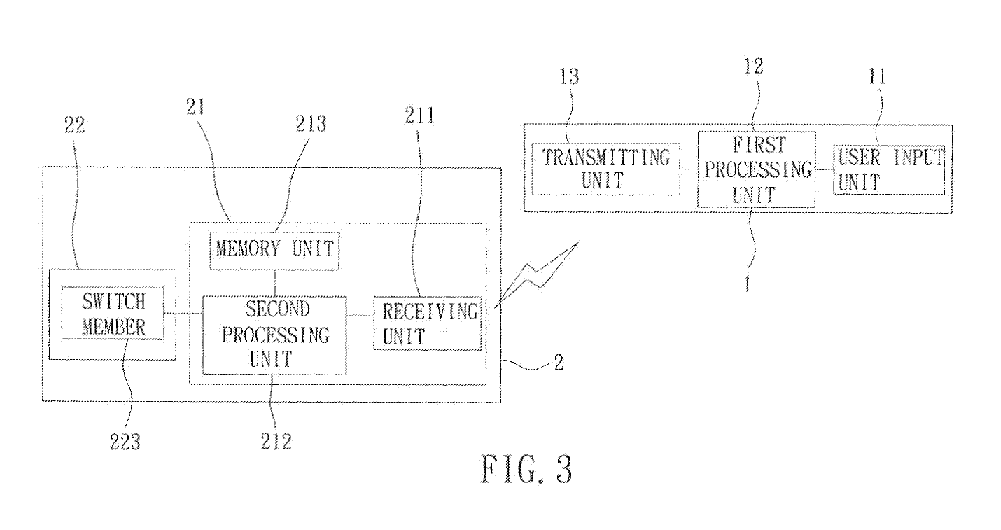

Referring to FIG. 3, a modification of the controlled module 22 of the first preferred embodiment is illustrated. The controlled module 22 includes a switch member 223. The control signal is transmitted to the switch member 223 of the controlled module 22 when the first key conforms with the first code, and the switch member 223 is switched between ON and OFF states according to the control signal from the second processing unit 212. In another modification of the controlled module 22 of the first preferred embodiment, the controlled module 22 includes a multi-position switch member that is switched to a desired switch position according to the control signal from the second processing unit 212.

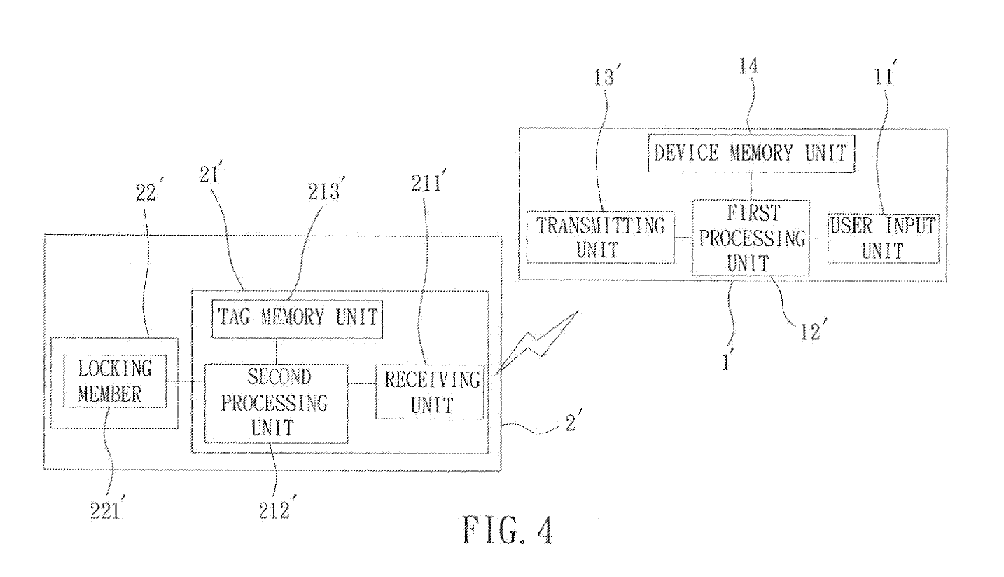

Referring to FIG. 4, a second preferred embodiment of the control system of the present invention includes a portable electronic device 1′ and a controlled device 2′. The portable electronic device 1′ and the controlled device 2′ communicate with each other wirelessly.

The portable electronic device 1′ includes a user input unit 11′ a first processing unit 12′, a transmitting unit 13′, and a device memory unit 14 storing a second key. The user input unit 11′ includes a plurality of input keys (not shown). The first processing unit 12′ is electrically coupled to the user input unit 11′, generates a first key and a control command according to user operation of the user input unit 11′, and is electrically coupled to the device memory unit 14 for accessing the second key stored in the device memory unit 14. The transmitting unit 13′ is electrically coupled to the first processing unit 12′ for wirelessly transmitting the first key, the control command, and the second key to the controlled device 2′.

The controlled device 2′ includes a RFID tag 21′ and a controlled module 22′. The REID tag 21′ includes a receiving unit 211′, a tag memory unit 213′, and a second processing unit 212′. The receiving unit 211′ is electrically coupled to the second processing unit 212′ for transmitting the first key, the control command, and the second key wirelessly received from the transmitting unit 13′ of the portable electronic device 1′ to the second processing unit 212′. The tag memory unit 213′ stores a first code, a second code, and an error count. The second processing unit 212′ is electrically coupled to the receiving unit 211′ and the tag memory unit 213′ and is further electrically coupled to the controlled module 22′. The second processing unit 212′ is configured to determine, with reference to the first and second keys received by the receiving unit 211′ and the first and second codes stored in the tag memory unit 213′, whether or not to output a control signal for controlling the controlled module 22′ to perform an action that corresponds to the control command received by the receiving unit 211′.

In the second preferred embodiment, the portable electronic device 1′ is a mobile phone, and includes an RFID reader for transmission of the first key, the second key, and the control command. The controlled device 2′ is a locking device, and the controlled module 22′ includes a locking member 221′.

An operational procedure of the second preferred embodiment of the present invention is illustrated hereinafter.

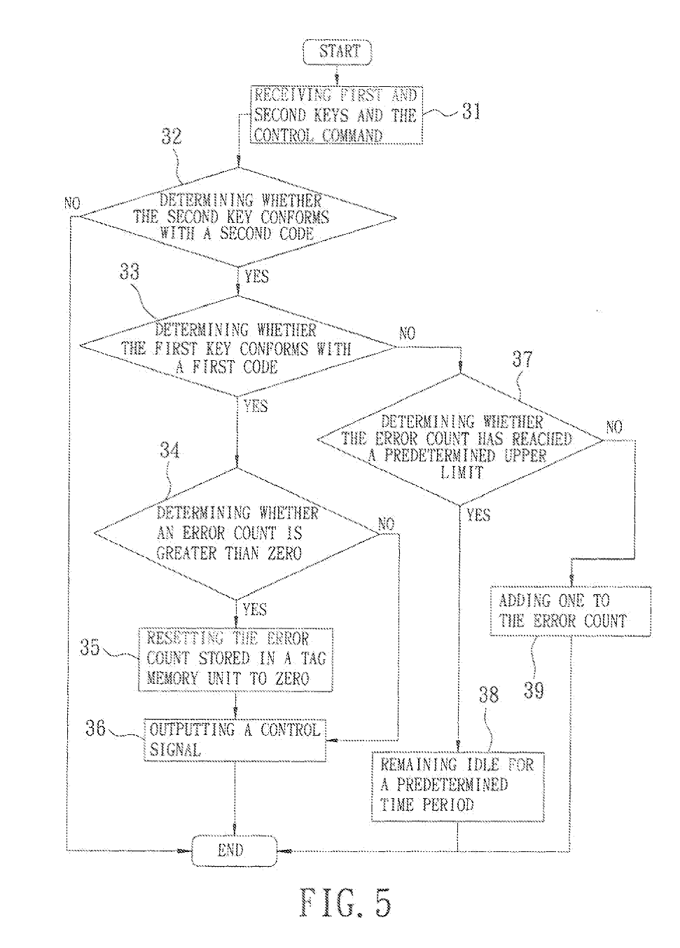

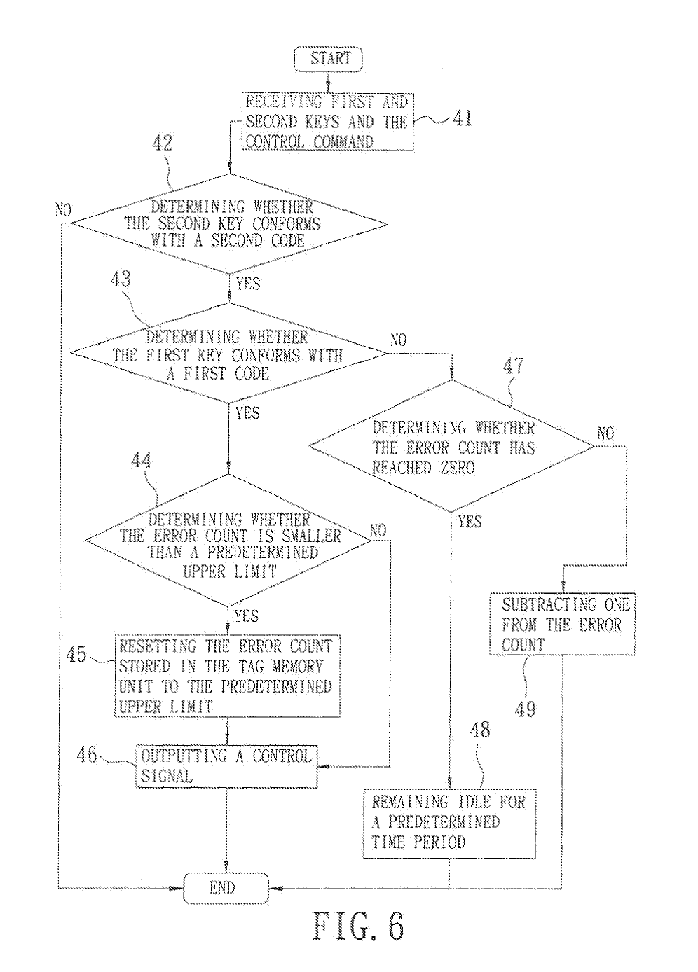

Referring to FIG. 5 and FIG. 6, operational procedure of the controlled device 2′ may be one of an accumulative scheme and subtractive scheme in updating the error count.

The Accumulative Scheme:

In step 31, the receiving unit 211′ receives the first key, the second key and the control command, and then step 32 is performed.

In step 32, the second processing unit 212′ makes a first determination to determine whether the second key conforms with the second code stored in the tag memory unit 213′. If result of the first determination is affirmative, step 33 is performed. Otherwise, the operational procedure is terminated.

In step 33, the second processing unit 212′ makes a second determination to determine whether the first key conforms with the first code stored in the tag memory unit 213′. If result of the second determination is affirmative, step 34 is performed. Otherwise, step 37 is performed.

In step 34, the second processing unit 212′ makes a third determination to determine whether the error count stored in the tag memory unit 213′ is greater than zero. If result of the third determination is affirmative, step 35 is performed. Otherwise, step 36 is performed.

In step 35, the second processing unit 212′ resets the error count stored in the tag memory unit 213′ to zero, and then step 36 is performed.

In step 36, the second processing unit 212′ outputs the control signal to the controlled module 22′, and then the operational procedure is terminated.

In step 37, the second processing unit 212′ makes a fourth determination to determine whether the error count stored in the tag memory unit 213′ has reached a predetermined upper limit (or a predetermined threshold). If result of the fourth determination is affirmative, step 38 is performed. Otherwise, step 39 is performed.

In step 38, the second processing unit 212′ remains idle for a predetermined time period, and then the operational procedure is terminated.

In step 39, the second processing unit 212′ adds one to the error count stored in the tag memory unit 213′, and then the operational procedure is terminated.

The Subtractive Scheme:

In step 41, the receiving unit 211′ receives the first key, the second key and the control command, and then step 42 is performed.

In step 42, the second processing unit 212′ makes a first determination to determine whether the second key conforms with the second code stored in the tag memory unit 213′. If result of the first determination is affirmative, step 43 is performed. Otherwise, the operational procedure is terminated.

In step 43, the second processing unit 212′ makes a second determination to determine whether the first key conforms with the first code stored in the tag memory unit 213′. If result of the second determination is affirmative, step 44 is performed. Otherwise, step 47 is performed.

In step 44, the second processing unit 212′ makes a third determination to determine whether the error count stored in the tag memory unit 213′ is smaller than a predetermined upper limit. If result of the third determination is affirmative, step 45 is performed. Otherwise, step 46 is performed.

In step 45, the second processing unit 212′ resets the error count stored in the tag memory unit 213′ to the predetermined upper limit, and then step 46 is performed.

In step 46, the second processing unit 212′ outputs the control signal to the controlled module 22′, and then the operational procedure is terminated.

In step 47, the second processing unit 212′ makes a fourth determination to determine whether the error count stored in the tag memory unit 213′ has reached zero (or a predetermined threshold). If result of the fourth determination is affirmative, step 48 is performed. Otherwise, step 49 is performed.

In step 48, the second processing unit 212′ remains idle for a predetermined time period, and then the operational procedure is terminated.

In step 49, the second processing unit 212′ subtracts one from the error count stored in the tag memory unit 213′, and then the operational procedure is terminated.

In both of the accumulative scheme and the subtractive scheme, the second processing unit 212′ will transmit the control signal to the controlled module 22′ only when each of the first and second keys received by the receiving unit 211′ conforms with a respective one of the first and second codes stored in the tag memory unit 213′. The locking member 221′ of the controlled module 22′ is switched between locking and unlocking states according to the control signal from the second processing unit 212′. It is noted that the second key and the second code are used for ensuring that the portable electronic device 1′ and the controlled device 2′ are matching devices.

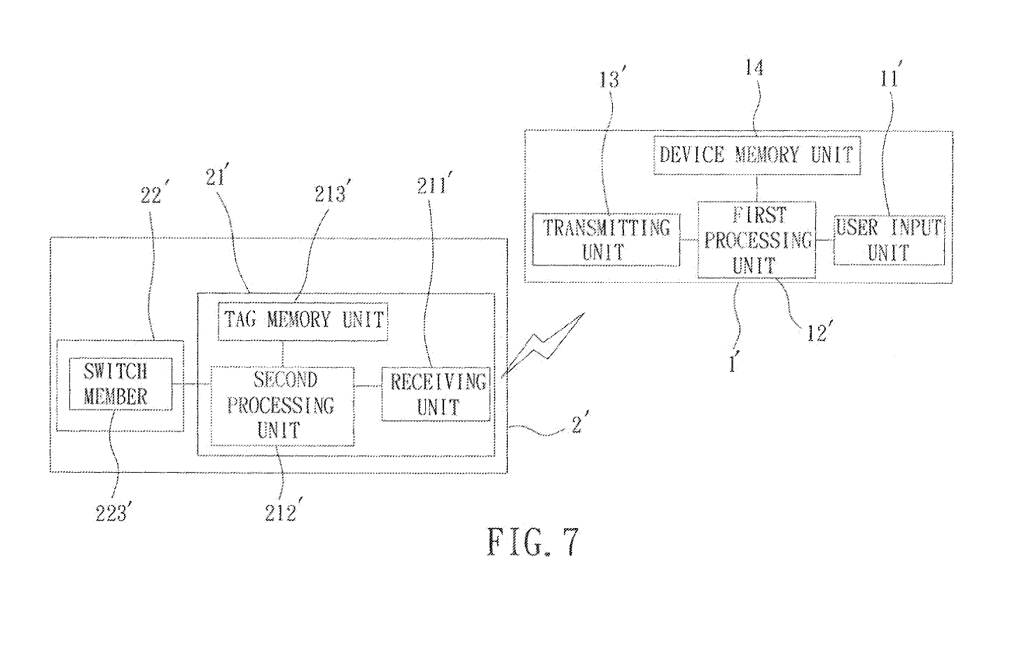

Referring to FIG. 7, a modification of the controlled module 22′ of the second preferred embodiment is illustrated. The controlled module 22′ includes a switch Member 223′. The control signal is transmitted to the switch member 223′ of the controlled module 22′ when each of the first and second keys received from the receiving unit 211′ conforms with a respective one of the first and second codes stored in the tag memory unit 213′. The switch member 223′ is switched between ON and OFF states according to the control signal from the second processing unit 212′. In another modification of the controlled module 22′ of the second preferred embodiment the controlled: module 22′ includes a multi-position switch member that is switched to a desired switch position according to the control signal from the second processing unit 212′.

In summary, the first and second preferred embodiments of the control system of the present invention have the following advantages over the conventional control system.

First, the RFID tag 21 is disposed in the controlled device 2. Since a cost of the RFID tag is relatively low with respect to that of the RFID reader, a cost of the controlled device 2 may be reduced by incorporating the RFID tag into the controlled device 2.

Second, the second preferred embodiment of the present invention adopts a two-stage code-matching scheme that offers better security. The second processing unit 212′ remains idle for the predetermined time period when the error count, which is updated when the first key does not conform with the first code, has reached the predetermined threshold. The longer the predetermined time period, the better will be the security of the present invention.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A controlled device comprising:
a controlled module; and
a radio frequency identification (REID) tag including:
a receiving unit for wirelessly receiving a first key and a control command;
a memory unit for storing a first code; and
a processing unit electrically coupled to said receiving unit and said memory unit and further electrically coupled to said controlled module,
wherein said processing unit is configured to determine, with reference to the first key received by said receiving unit and the first code stored in said memory unit, whether or not to output a control signal for controlling said controlled module to perform an action that corresponds to the control command received by said receiving unit.

2. The controlled device as claimed in claim 1, wherein said processing unit of said RFID tag outputs the control signal upon determining that the first key received by said receiving unit corresponds with the first code stored in said memory unit.

3. The controlled device as claimed in claim 1, wherein said controlled module includes a locking member that is switched between locking and unlocking states according to the control signal from said processing unit.

4. The controlled device as claimed in claim 1, wherein said controlled module includes a switch member that is switched between ON and OFF states according to the control signal from said processing unit.

5. The controlled device as claimed in claim 1, wherein said controlled module includes a multi-position switch member that is switched to a desired switch position according to the control signal from said processing unit.

6. The controlled device as claimed in claim 1, wherein said receiving unit of said RFID tag further wirelessly receives a second key, said memory unit of said RFID tag further storing a second code, said processing unit of said RFID tag being configured to determine whether or not to output the control signal with reference to the first and second keys received by said receiving unit and the first and second codes stored in said memory unit.

7. The controlled device as claimed in claim 6, wherein said memory unit further stores an error count, said processing unit of said RFID tag being further configured to determine whether or not to update the error count stored in said memory unit according to the first key received by said receiving unit and the first code stored in said memory unit, and to remain idle for a predetermined time period when the error count reaches a predetermined threshold.

8. The controlled device as claimed in claim 7, wherein said processing unit is configured:
to make a first determination to determine whether the second key received by said receiving unit corresponds with the second code stored in said memory unit,
to make a second determination to determine whether the first key received by said receiving unit corresponds with the first code stored in said memory unit when result of the first determination is affirmative,
to output the control signal when result of the second determination is affirmative, and
to update the error count if the error count has yet to reach the predetermined threshold, and to remain idle for the predetermined time period if otherwise, when the result of the second determination is negative.

9. A control system comprising:
a portable electronic device including:
a user input unit;
a first processing unit, electrically coupled to said user input unit, for generating a first key and a control command according to user operation of said user input unit; and
a transmitting unit, electrically coupled to said first processing unit, for wirelessly transmitting the first key and the control command; and
a controlled device including:
a controlled module; and
a radio frequency identification (RFID) tag including a receiving unit for wirelessly receiving the first key and the control command from said transmitting unit of said portable electronic device, a tag memory unit for storing a first code, and a second processing unit electrically coupled to said receiving unit and said tag memory unit and further electrically coupled to said controlled module,
said second processing unit being configured to determine, with reference to the first key received by said receiving unit and the first code stored in Said tag memory unit, whether or not to output a control signal for controlling said controlled module to perform an action that corresponds to the control command received by said receiving unit.

10. The control system as claimed in claim 9, wherein said second processing unit outputs the control signal upon determining that the first key received by said receiving unit corresponds with the first code stored in said tag memory unit.

11. The control system as claimed in claim 9, wherein said controlled module includes a locking member that is switched between locking and unlocking states according to the control: signal from said second processing unit.

12. The control system as claimed in claim 9, wherein said controlled module includes a switch member that is switched between ON and OFF states according to the control signal from said second processing unit.

13. The control system as claimed in claim 9, wherein said controlled Module includes a multi-position switch member that is switched to a desired switch position according to the control signal from said second processing unit.

14. The control system as claimed in claim 9, wherein said portable electronic device further includes a device memory unit electrically coupled to said first processing unit, said device memory unit storing a second key, said first processing unit accessing the second key stored in said device memory unit, said transmitting unit wirelessly transmitting the second key accessed by said first processing unit together with the first key and the control command for reception by said receiving unit of said RFID tag, said tag memory unit of said RFID tag further storing a second code, said second processing unit of said RFID tag being configured to determine whether or not to output the control signal with reference to the first and second keys received by said receiving unit and the first and second codes stored in said tag memory unit.

15. The control system as claimed in claim 14, wherein said tag memory unit further stores an error count, said second processing unit being further configured to determine whether or not to update the error count stored in said tag memory unit according to the first key received by said receiving unit and the first code stored in said tag memory unit, and to remain idle for a predetermined time period when the error count reaches a predetermined threshold.

16. The control system as claimed in claim 15, wherein said processing unit is configured:
to make a first determination to determine whether the second key received by said receiving unit corresponds with the second code stored in said tag memory unit,
to make a second determination to determine whether the first key received by said receiving unit corresponds with the first code stored in said tag memory unit when result of the first determination is affirmative,
to output the control signal when result of the second determination is affirmative, and
to update the error count if the error count has yet to reach the predetermined threshold, and to remain idle for the predetermined time period if otherwise, when the result of the second determination is negative.
